(19) United States
(12) Patent Application Publication
(10) Pub. No.: US 2008/0288882 A1
(43) Pub. Date: Nov. 20, 2008

(54) Systems and methods for privacy service

(76) Inventor: THomas Andrew Fink, Dayton, OH (US)

Correspondence Address: Thomas Andrew Fink, 3136 Indian Ripple Road, Dayton, OH, 45440, US

(21) Appl. No.: 12/152,703

(22) Filed: May 15, 2008

Related U.S. Application Data
(60) Provisional application No. 60/930,197, filed on May 15, 2007.

(51) Int. Cl. G06Q 10/00; G06F 3/048

(52) U.S. Cl. 715/764; 705/10

(57) ABSTRACT

Systems and methods are disclosed that utilize privacy services to improve Internet shopping. In particular, a method for improving Internet shopping comprises providing a visual indicator to a plurality of websites for display on the websites, the visual indicator is indicative of a single privacy policy shared amongst the websites; receiving a request from a consumer via the visual indicator on one of the websites; and, displaying to the consumer in response to the consumer request the shared privacy policy and confirmation that the one of the websites uses the shared privacy policy.

### CROSS-REFERENCE TO RELATED APPLICATIONS

This application claims the benefit of provisional patent application No. 60/930,197 filed May 15, 2007 by the present inventor.

### BACKGROUND

The Internet has provided opportunities for businesses to sell goods and services online. With these opportunities have come challenges.

To complete sales transactions over the Internet, consumers need to transfer personally identifiable information. Because many consumers are weary of credit card fraud, identity theft, and other problems that can occur when their personally identifiable information is misused, convincing consumers to transfer their personally identifiable information over the Internet poses perhaps the greatest challenge to businesses wishing to sell online. Many consumers refuse to use the Internet for sales transactions altogether, while others selectively use the Internet to buy goods and services depending on their level of trust in a particular Internet business.

These selective Internet users tend to trust business with which they are familiar. These familiar businesses tend to be larger businesses that are well known in the marketplace. Thus, one can easily understand that start-up businesses (start-ups) and other small businesses face an additional challenge of gaining the trust of selective Internet users to whom they are not well known.

To address these challenges, small businesses have followed the lead of big businesses by adding a privacy policy page to their website. From the consumer's perspective, these privacy policies can be useful. However, due to the nature of a privacy policy's subject matter, namely computer technologies and privacy laws, consumers often find it difficult and thus time consuming to read and understand privacy policies. When comparison-shopping, consumers are often faced with the task of reading and understanding multiple privacy policies in order to make informed decisions.

From the perspective of small businesses, privacy policies offer no help in improving the familiarity of any aspect of the small businesses with consumers. Also, due to the nature of the subject matter of a privacy policy, consumers do not often read the privacy policies.

Because privacy policies are not often read, consumers have little reason to increase their trust in a small business solely based on a privacy policy. Therefore, small businesses sometimes follow the lead of big businesses by paying a company to review their privacy policy. Upon review, small businesses are licensed to display the company seal of the reviewer.

The familiarity of these company seals with can boost consumer confidence in a small business. However, from the perspective of small businesses, these review processes can be costly, confusing, and time consuming. Also, since these seals are used in conjunction with many different privacy policies, small businesses can face an unwanted association with other businesses' privacy policies that can be relatively less desirable to consumers. From the perspective of consumers, even with the seal of a review company, consumers must still read and understand each individual privacy policy to be sure of its exact content.

Thus, it is desirable to provide an invention that offers improvements for consumers and small businesses as they shop and sell via the Internet.

### SUMMARY

With the desire to improve the operating environment for small businesses that sell products and services via the Internet and for consumers that choose to shop via the Internet, I have invented Systems and Methods for Privacy Service. Depending on the selected embodiment of the Systems and Methods for Privacy Service, the present invention provides one or more of the following benefits:
A). Provides a technology tool that simplifies the Internet shopping experience for consumers by sharing the same privacy policy amongst all participants in the privacy service;
B). Provides a technology tool that improves the retention rate of the terms of a privacy policy among consumers;
C). Provides a technology tool that eliminates the need to differentiate individual privacy policies in order to circumvent copyright liabilities;
D). Provides a technology tool that eliminates the need to perform a costly, time consuming, and confusing review process and associated modification process for each individual privacy policy of each small business;
E). Provides a technology tool for pooling marketing resources to encourage completion of Internet sales;
F). Provides a technology tool that offers consumers a one click method of displaying a privacy policy and confirmation of participation in the privacy service;
G). Provides a technology tool that allows small businesses to gain the trust of customers online by increasing the familiarity of the small business' privacy policy; and
H). Provides a technology tool that offers a logo that is representative of a single privacy policy.

Other benefits will be understood as details describing the present invention are described here forth. To provide these benefits, my development efforts led to a method for improving Internet shopping comprising providing a visual indicator to a plurality websites for display on the websites with the visual indicator being indicative of a single privacy policy shared amongst the websites; receiving a request from a consumer via the visual indicator one of the websites; and, displaying to the consumer in response to the consumer request the shared privacy policy and confirmation that the one of the websites uses the shared privacy policy. The request is preferably triggered by a single click from the computer mouse of the consumer.

Additionally, the method can further comprise one or more of the following steps:
a.) displaying to the consumer in response to the consumer request a plurality of graphical mnemonics corresponding to terms of the shared privacy policy to aid consumer retention of the terms of the shared privacy policy;
b.) confirming to the consumer in response to the consumer request that the one of the websites has not been known to significantly violate terms of the shared privacy policy;
c.) receiving input from consumers concerning preferred content of the shared privacy policy; and using the consumer input to make a change to the shared privacy policy;
d.) receiving input from consumers concerning preferred content of the shared privacy policy; using the consumer input to create a proposed change to the shared privacy policy; displaying the proposed change to the shared privacy policy to consumers; receiving input from consumers concerning the proposed change to the shared privacy policy; and making the proposed change to the shared privacy policy.

The present invention can also be embodied as a computer system for improving Internet shopping. The computer system comprises a data storage device for storing a single privacy policy shared amongst a plurality of websites and a record of the websites who share the single privacy policy; and

a processor coupled to the data storage device. The processor being operative to perform the steps of providing a visual indicator to a plurality of websites for display on the websites, the visual indicator being indicative of the single privacy policy shared amongst the websites; receiving a request from a consumer via the visual indicator on one of the websites; and displaying to the consumer in response to the consumer request the shared privacy policy and confirmation that the one of the websites is present in the record of websites who share the privacy policy. The request is preferably triggered by a single click from the computer mouse of the consumer.

Additionally, the processor can be further operative to perform one or more of the following steps:
a.) displaying to the consumer in response to the consumer request a plurality of graphical mnemonics corresponding to terms of the shared privacy policy to aid consumer retention of the terms of the shared privacy policy;
b.) confirming to the consumer in response to the consumer request that the one of the websites has not been known to significantly violate terms of the shared privacy policy;
c.) receiving input from consumers concerning preferred content of the shared privacy policy; and using the consumer input to make a change to the shared privacy policy;
d.) receiving input from consumers concerning preferred content of the shared privacy policy; displaying a proposed change to the shared privacy policy to consumers, wherein the proposed change is based on the consumer input; receiving input from consumers concerning the proposed change to the shared privacy policy; and displaying the shared privacy policy after the proposed changes have been made to the shared privacy policy.

### BRIEF DESCRIPTION OF DRAWINGS

These and other benefits and advantages of the present invention will become better understood with regard to the following description, and accompanying drawings where:

FIG. 1 is a general illustration of the privacy service systems and methods of the present invention.

FIG. 2 shows a flow chart that summarizes the general services provided by the privacy service provider.

FIG. 3 is an illustration of a small business web site.

FIG. 4 is an illustration of the website of the privacy service provider.

FIG. 5 is an illustration of preferred services of the privacy service provider

FIG. 6 is an illustration of the Internet platform on which the privacy service is provided.

FIG. 7 is an illustration of the server machine.

FIG. 8 is a flow chart summarizing steps that allow consumers to control the content of the shared privacy policy.

### DESCRIPTION

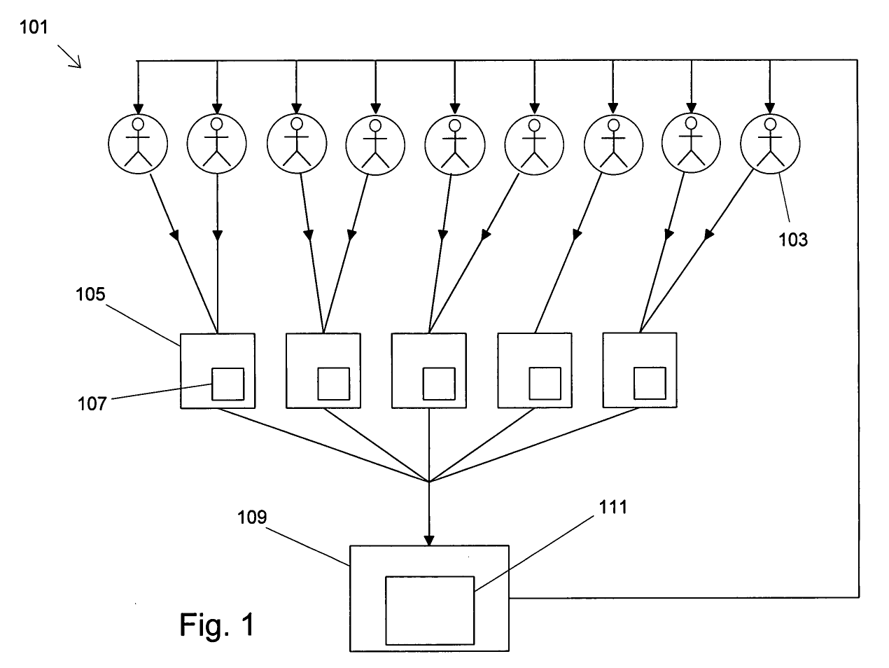

FIG. 1 provides a general illustration of the privacy service 101 of the present invention. Via the Internet, consumers 103 decide whether or not to provide personally identifiable information to small-business web sites 105.

Each small-business web site provides consumers with a visual indicator 107 for requesting service from a privacy service provider. The privacy service provider 109 receives a request from a consumer via a particular small-business web site and subsequently confirms that the particular small business participates in the privacy service. The privacy service then displays confirmation of the particular small business's participation, and a privacy policy shared amongst all the small businesses 111. The term privacy policy is used herein to refer to a policy that addresses issues and practices relating to the privacy and security of consumer information, specifically personally identifiable information.

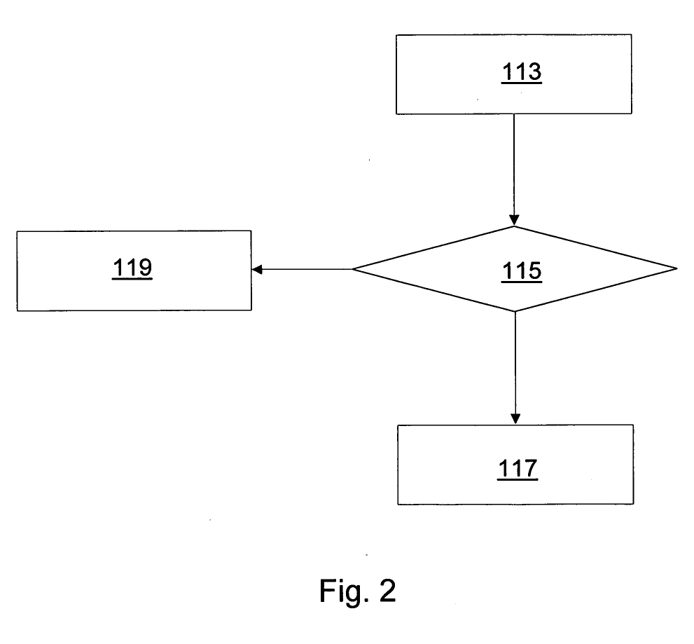

FIG. 2 shows a flow chart that summarizes the services provided by the privacy service provider. First 113, via a visual indicator on a small business website, the privacy service provider receives a request for service from a consumer. Next 115, the privacy service provider confirms that the particular small business participates in the privacy service. If the small business does participate in the privacy service, next 117, the privacy service then displays confirmation of the particular small business's participation, and a privacy policy shared amongst all the small businesses. If the small business does not participate in the privacy service, next 119, the privacy service displays an indication that the privacy service is not a participant in the privacy service. This could happen, for example, if the small business did not pay its fees to the privacy service provider on time.

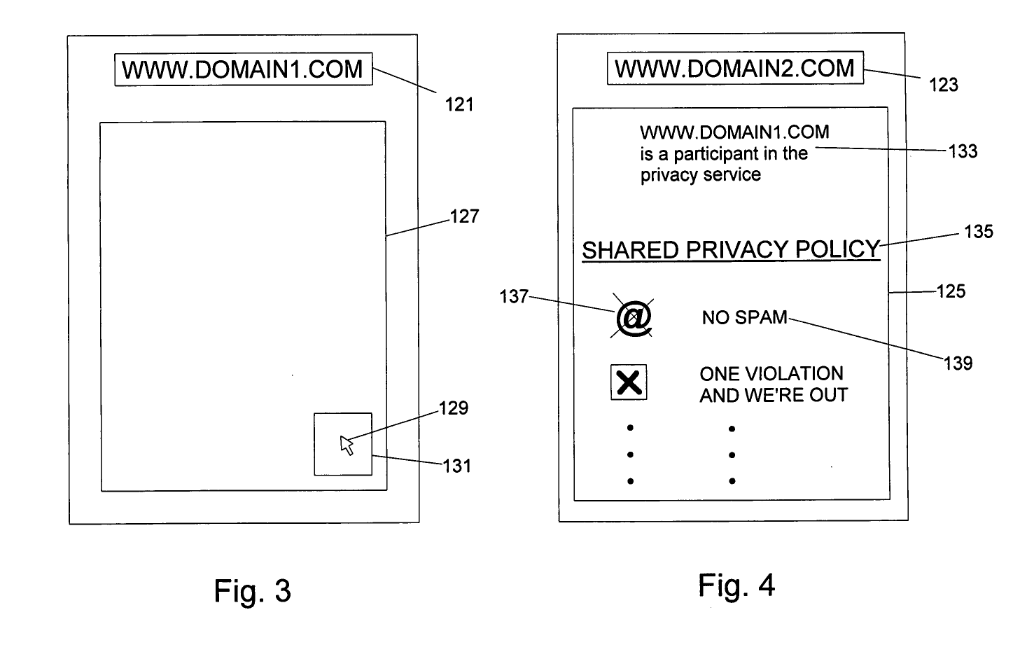

As shown in FIG. 3, preferably, this display occurs such that the consumer is directed from the domain of the small business web site (www.domain1.com) 121 to the domain of the privacy service provider web site (www.domain2.com) 123 within the current browser window, or within separately tabbed browser window or pop-up browser window. Thus, the privacy policy shared amongst the small businesses is itself be part of the privacy service provider's web site 125, rather than part of the individual small business web site 127. This allows consumers to receive, with one click 129 on the logo 131, both a confirmation 133 that the small business web site is a participant in the privacy service, and the shared privacy policy 135.

The visual indicator is preferably a logo, which is used by all the small businesses participating in the privacy service. By clicking on the logo, the consumer sends a request to the privacy service provider. The request includes an identifier for identifying the particular small business, for example the domain name under which the small business operates its web site. The privacy service provider then displays to the consumer the privacy policy that is shared amongst all small businesses that participate in the privacy service.

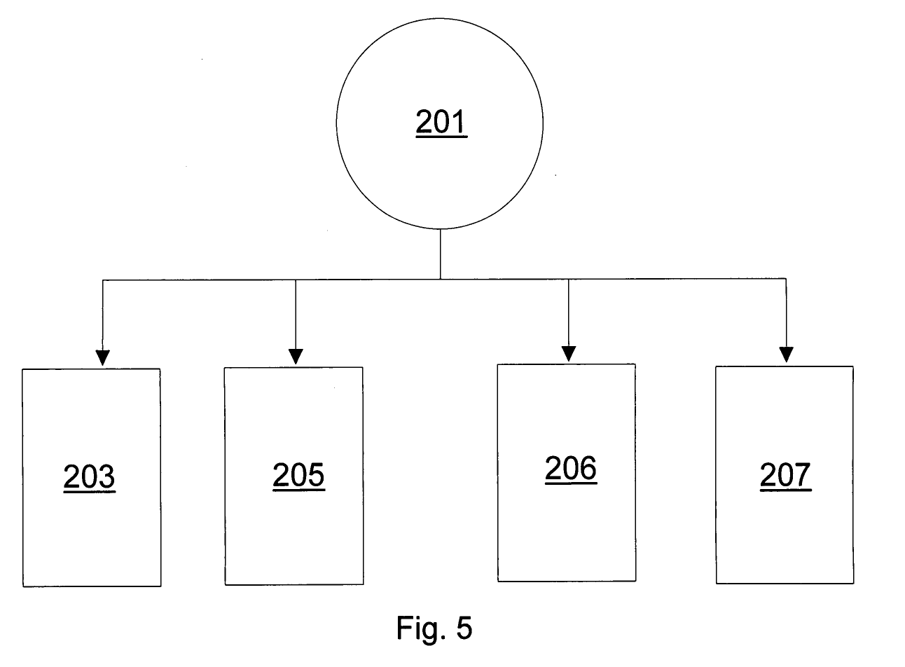

As shown in FIG. 4, to aid consumer retention of the terms of the shared privacy policy, the shared privacy policy preferably includes a plurality of graphical mnemonics 137 corresponding to a plurality of terms 139 in the shared privacy policy. For example, a term stating “NO SPAM” has a corresponding graphical mnemonic of a crossed out “@” (at symbol). These graphical mnemonics aid consumer retention of the terms of the privacy policy. These graphical mnemonics act as visual representations of the terms associated with the graphical mnemonic.

For consumers, no matter which web site displays the logo, the logo represents the shared privacy policy. This allows consumers to save time by familiarizing themselves with a single privacy policy that applies to all small businesses that participate in the privacy service. Having previously familiarized themselves with the shared privacy policy, consumers do not necessarily need to read all or any of the shared privacy policy again depending on their retention of the shared privacy policy.

It is preferred that the small business website exclusively use the shared privacy policy without additions, subtractions, amendments, or the like appearing elsewhere. Thus, the shared privacy policy represents the complete and only privacy policy for the small business.

The privacy service of the present invention offers many benefits to consumers. When a consumer attempts to make a decision on whether or not to provide personally identifiable information to a small business, the privacy service simplifies the decision making process by having a shared privacy policy for all small businesses that participate in the privacy service. Because the logo represents the shared privacy policy, consumers can instantly be familiar with privacy policy of any small business that displays the logo. Familiarity with the shared privacy policy translates into a reduction in the time it takes to make decisions. Additionally, the graphical mnemonics for associated terms in the privacy policy improve the recall and retention of the terms of the shared privacy policy.

As shown in FIG. 5, preferably, the privacy service 201 also includes marketing services 203 to market the shared privacy policy. Because the privacy policy is shared, part of the fees paid to the privacy service provider is applied to marketing the shared privacy policy to consumers. This pooling effect allows small businesses to reap greater consumer awareness than they could otherwise achieve alone.

Preferably, the privacy service also includes law compliance services 205. The law compliance services comprise law monitoring services, and shared privacy policy adjustment services. The law monitoring services comprise monitoring of privacy related laws affecting the operation of small businesses, for example federal and state privacy laws. As laws change, the shared privacy policy is adjusted to comply with the changes.

Preferably, the privacy service also provides consumer testing-services 206 to test consumer reaction to aspects of the privacy service, for example testing of shared privacy policy terms, logo, and visual representations. This consumer testing allows all aspects of the privacy service to be optimized to insure the most favorable reaction from consumers. Periodically, the results of the consumer testing services are used to improve the privacy service according to the desires of consumers.

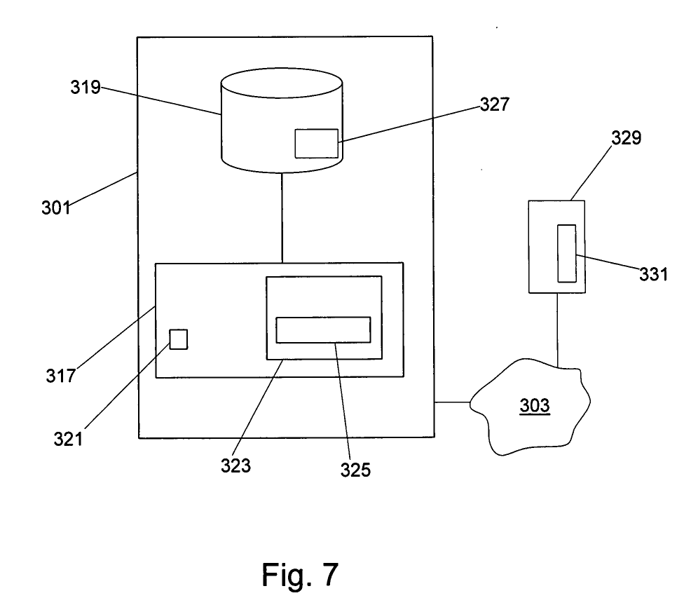

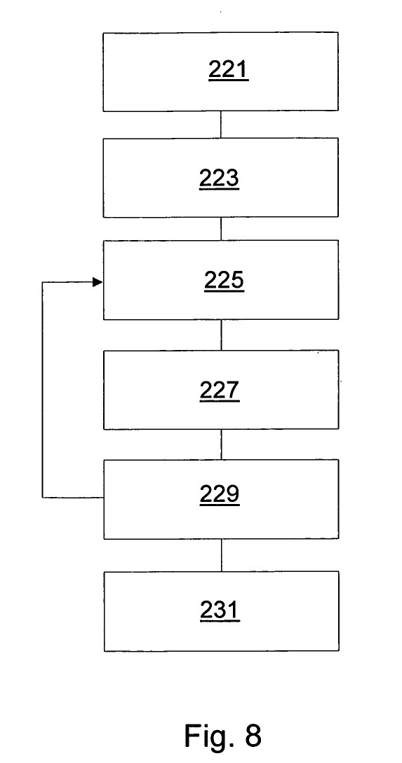

As shown in FIG. 7, it is preferred that the consumer testing services include processes that allow the consumer to determine the terms of the privacy policy. For example, a service could include receiving input from consumers concerning the terms of the shared privacy policy or the privacy service 221, accessing the consumer input 223, proposing changes to the shared privacy policy or the privacy service based on the consumer input 225, displaying the proposed changes to consumers 227, receiving input from consumers concerning the proposed changes to the shared privacy policy or the privacy service 229, and changing the shared privacy policy or privacy service according to the desires of consumers 231. If necessary, proposed changes that are not well received by consumers can be fed back, changed, and proposed again 225. Improving the privacy service and the shared privacy policy according to the desires of consumers reverses the usual practice wherein each the website determines the content of their own personal privacy policy according to their own desires. Thus, by improving the privacy service and the shared privacy policy according to the desires of consumers, consumers control the content of the shared privacy policy, not websites. When a consumer sees the logo for the shared privacy policy, he or she can be assured that the content of the shared privacy policy is controlled by consumers, not websites.

Preferably, the privacy service also provides compliance services 207 to insure small business websites are following the terms of the shared privacy policy. The compliance services comprise receiving consumer feedback on compliance violations, accessing the violations, and removing websites from the privacy service. It is preferred that the small business website be removed from the privacy service forever if they are found to violate the terms of the shared privacy policy in a significant manner. For example, one major violation or a pattern of minor violations could be considered significant, and therefore would be grounds for removing a particular website from the privacy service forever.

With these compliance services, when a consumer sees the logo or clicks on the logo of the shared privacy policy, he or she instantly knows that the website has not violated the terms of the shared privacy policy in a significant manner. Thus, for consumers, the logo of the shared privacy policy not only represents the shared privacy policy, but also assurance that the terms of the shared privacy policy have not been significantly violated.

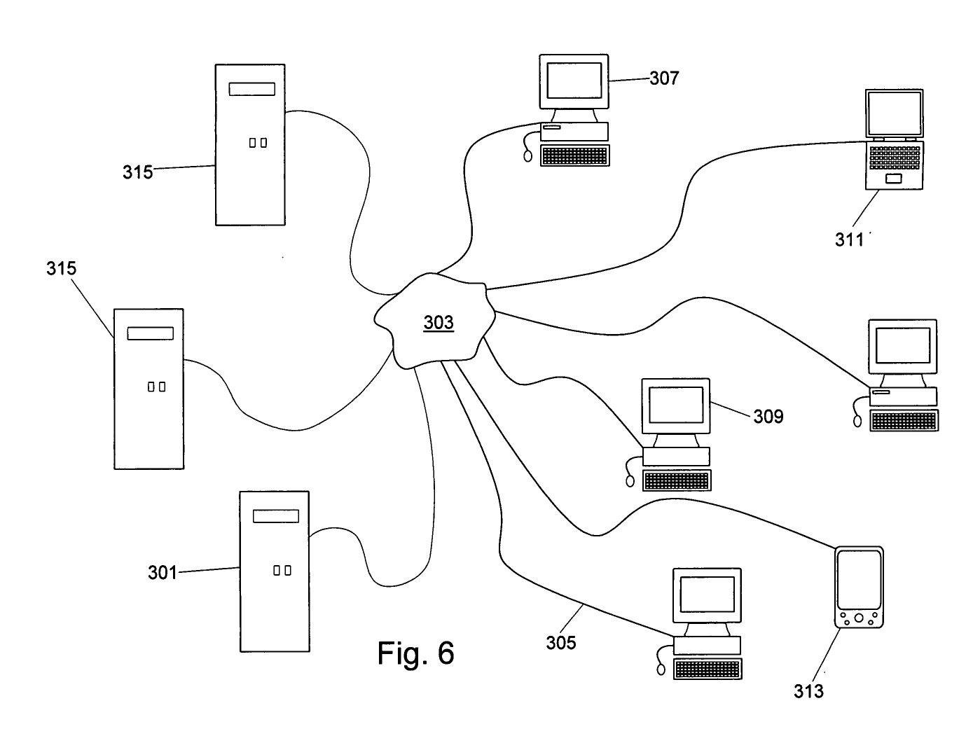

As shown in FIG. 6, the preferred embodiment of the privacy service provider comprises a server machine 301 operating a website available via the global Internet 303 communications network known as the World Wide Web. Via an Internet connection 305, while operating web browser software on a personal computer 307, workstation 309, laptop computer 311, PDA 313, or the like, consumers access small business websites operated by server machines 315. Via a logo on the small business websites, consumers request service from a privacy service provider.

As shown in FIG. 7, the server machine 301 comprises a web server 317, and a database 319. The web server comprises a processor 321 coupled to a memory storage device 323. The memory storage device (e.g., RAM or hard drive) contains scripts 325 for receiving and processing requests from consumers, and for storing and retrieving participant data 327 from the database for use in processing the consumer requests 329. The consumer requests include identifier data 331 for identifying the small business website via which the consumer request was made.

In general, devices and systems consistent with the present invention provide an improved privacy service that benefits both consumers and websites. The above detailed description enables one skilled in the art of the present invention to make, use, and thus experience the novel benefits of the present invention. It will be apparent to one skilled in the art that other embodiments, modifications, and variations consistent with the present invention are possible, and that practicing the teachings of the present invention provided herein shall yield still further embodiments, modifications, and variations of the present invention. For example, referring to FIG. 4, the shared privacy policy 125 could comprise any terms 139 desired by consumers, the visual indicator 131 could be any visual element that indicates the website's use of the shared privacy policy, the confirmation 133 could be any type of visual element that confirms that the small business website is a participant in the privacy service (i.e., uses the shared privacy policy and agrees to terms of the privacy policy) and the graphical mnemonics 137 shown in FIG. 4 could comprise any graphical symbols desirable to consumers.

Thus, as one can easily see, although the description above contains many specificities, these should not be construed as limiting the scope of the present invention but as merely providing illustrations of the presently preferred embodiment of the present invention. It is therefore critical that the scope of the present invention should be defined strictly by the appended claims and their equivalents.

1. A method for improving Internet shopping, comprising:
providing a visual indicator to a plurality websites for display on the websites, the visual indicator being indicative of a single privacy policy shared amongst the websites;
receiving a request from a consumer via the visual indicator one of the websites; and
displaying to the consumer in response to the consumer request the shared privacy policy and confirmation that the one of the websites uses the shared privacy policy.

2. The method of claim 1 wherein the consumer request is triggered by a single click from the computer mouse of the consumer.

3. The method of claim 2 further comprising one or more steps selected from a group consisting of:
a.) displaying to the consumer in response to the consumer request a plurality of graphical mnemonics corresponding to terms of the shared privacy policy to aid consumer retention of the terms of the shared privacy policy;
b.) confirming to the consumer in response to the consumer request that the one of the websites has not been known to significantly violate terms of the shared privacy policy;
c.) receiving input from consumers concerning preferred content of the shared privacy policy; and
using the consumer input to make a change to the shared privacy policy;
d.) receiving input from consumers concerning preferred content of the shared privacy policy;
using the consumer input to create a proposed change to the shared privacy policy;
displaying the proposed change to the shared privacy policy to consumers;
receiving input from consumers concerning the proposed change to the shared privacy policy;
making the proposed change to the shared privacy policy;
e.) monitoring laws associated with the shared privacy policy; and
changing the privacy policy to comply with changes in the laws;
f.) collecting fees from the websites for use of the shared privacy policy;
and marketing the shared privacy policy to consumers with at least part of the fees collected from the websites to improve consumer familiarity with the shared privacy policy.

4. A computer system for improving Internet shopping, comprising:
a data storage device for storing a single privacy policy shared amongst a plurality of websites and a record of the websites who share the single privacy policy; and
a processor coupled to the data storage device, the processor being operative to perform the steps of:
providing a visual indicator to a plurality of websites for display on the websites, the visual indicator being indicative of the single privacy policy shared amongst the websites;
receiving a request from a consumer via the visual indicator on one of the websites; and
displaying to the consumer in response to the consumer request the shared privacy policy and confirmation that the one of the websites is present in the record of websites who share the privacy policy.

5. The computer system of claim 4 wherein the consumer request is triggered by a single click from the mouse of the consumer.

6. The computer system of claim 5 wherein the processor is further operative to perform one or more steps selected from a group consisting of:
a.) displaying to the consumer in response to the consumer request a plurality of graphical mnemonics corresponding to terms of the shared privacy policy to aid consumer retention of the terms of the shared privacy policy;
b.) confirming to the consumer in response to the consumer request that the one of the websites has not been known to significantly violate terms of the shared privacy policy;
c.) receiving input from consumers concerning preferred content of the shared privacy policy; and
using the consumer input to make a change to the shared privacy policy;
d.) receiving input from consumers concerning preferred content of the shared privacy policy;
displaying a proposed change to the shared privacy policy to consumers, wherein the proposed change is based on the consumer input;
receiving input from consumers concerning the proposed change to the shared privacy policy; and
displaying the shared privacy policy after the proposed changes have been made to the shared privacy policy;
e.) monitoring laws associated with the shared privacy policy; and
changing the privacy policy to comply with changes in the laws;
f.) collecting fees from the websites for use of the shared privacy policy;
and marketing the shared privacy policy to consumers with at least part of the fees collected from the websites to improve consumer familiarity with the shared privacy policy.
